(19) United States
(12) Patent Application Publication
(10) Pub. No.: US 2026/0155653 A1
(43) Pub. Date: Jun. 4, 2026

(54) POWER-SAVING ACTION MANAGEMENT DEVICE

(71) Applicant: NTT DOCOMO, INC., Tokyo (JP)

(72) Inventors: Fumiaki IGARASHI, Chiyoda-ku (JP); Masayasu SUMIYA, Chiyoda-ku (JP)

(73) Assignee: NTT DOCOMO, INC., Tokyo (JP)

(21) Appl. No.: 18/705,663

(22) PCT Filed: Sep. 14, 2022
(86) PCT No.: PCT/JP2022/034431

§ 371 Date: Apr. 29, 2024

(30) Foreign Application Priority Data
Nov. 18, 2021 (JP) 2021-187733

(51) Int. Cl. H02J 3/175; H02J 105/12; H02J 105/52

(52) U.S. Cl. CPC H02J 3/175; H02J 2105/12; H02J 2105/52

(57) ABSTRACT

A power-saving action management device includes: an information input unit configured to acquire information relating to a temporal change in power consumption of a power consuming device and information representing that the user has performed an intention expression operation that is an operation expressing an intention to spontaneously perform power saving; an analysis unit configured to analyze a relation between the change in the power consumption of the power consuming device and the user's intention expression operation; and a display unit configured to display a result of the analysis performed by the analysis unit, wherein the analysis unit identifies whether the user has performed a power-saving action for the power consuming device before/after the user's intention expression operation, and the display unit, in a case in which it is identified that the user has performed the power-saving action, displays the result.

### TECHNICAL FIELD

The present disclosure relates to a power-saving action management device.

### BACKGROUND ART

In a recent situation in which importance is placed on environment protection and energy problems, efforts for raising awareness on energy-saving activities including power saving have been carried out. As a technique for monitoring power consumption inside a house, for example, there is a home energy management system (HEMS; a home power management system) disclosed in Non-Patent Literature 1. However, this system has a high introduction cost for a general house which causes a large burden, and thus there are many problems in actual use thereof.

On the other hand, in Patent Literature 1, a technology in which a card company server acquires a usage amount with respect to power consumption in a user's home and records the usage amount as home appliance power usage information for promoting a power-saving action at home is disclosed. In addition, in Patent Literature 1, it is disclosed that, when a user purchases a service or a product using a card, purchase information including a date and time and a place is recorded, a home's power-saving amount and a purchase action are evaluated on the basis of a user's behavior record estimated from this purchase information, and an incentive to be given to the user is determined in accordance with the evaluation.

### CITATION LIST

### Patent Literature

[Patent Literature 1] Japanese Unexamined Patent Publication No. 2016-157472
[Non-Patent Literature 1] Ministry of Economy, Trade, and Industry, “Chapter 4 Research/Review for Creation of Management Service for Energy Saving for Residents etc. using the IoT and Big Data” [ONLINE], [Retrieved on Sep. 21, 2021], Internet <URL: https://www.meti.go.jp/policy/mono info service/mono/jyutaku/images/H27FY_houkokusyo.pdf>

### SUMMARY OF INVENTION

### Technical Problem

However, in the technique described in Patent Literature 1, it is difficult to evaluate whether a user himself or herself has intentionally performed a power-saving operation, and there is room for enhancement in terms of prompting a user to perform a power-saving action.

The present disclosure is in consideration of the description presented above, and an object thereof is to provide a technology capable of urging a user to perform a power-saving action by appropriately detecting a power-saving action of the user himself or herself.

### Solution to Problem

According to one aspect of the present disclosure, there is provided a power-saving action management device including: an information input unit configured to acquire information relating to a temporal change in power consumption of a power consuming device for which adjustment of power consumption can be performed by a user and information representing that the user has performed an intention expression operation that is an operation expressing an intention to spontaneously perform power saving; an analysis unit configured to analyze a relation between the change in the power consumption of the power consuming device and the user's intention expression operation; and a display unit configured to display a result of the analysis performed by the analysis unit, in which the analysis unit identifies whether the user has performed a power-saving action for the power consuming device before/after the user's intention expression operation, and the display unit, in a case in which it is identified by the analysis unit that the user has performed the power-saving action, displays the result.

In such an aspect, the analysis unit determines whether or not a user has actually performed a power-saving action from information representing that the user has performed an intention expression operation spontaneously expressing an intention to perform power saving and information relating to the temporal change in the power consumption of the power consuming device, and a result thereof is displayed in the display unit. By employing the configuration described above, it can be more appropriately determined whether the change in the power consumption of the power consuming device has originated from a user's intentional power-saving action. In other words, a user's power-saving action can be detected more accurately. In addition, by displaying that a power-saving action has been performed using the display unit, appropriate detection of a power-saving action is notified also to the user, and thus a user's power-saving action can be promoted.

### Advantageous Effects of Invention

According to the present disclosure, a technology capable of urging a user to perform a power-saving action by appropriately detecting a power-saving action of the user himself or herself is provided.

### BRIEF DESCRIPTION OF DRAWINGS

FIG. 1 is a block diagram illustrating one example of a configuration of a power-saving action management system.

FIG. 2 is a diagram illustrating one example of information that is acquired and retained by a management device.

FIG. 3 is a diagram illustrating one example of changes in power consumption of a power consuming device according to presence/absence of a power-saving action.

FIG. 4 is a diagram illustrating one example of an amount of reduction of power consumption according to a power-saving action.

FIG. 5 is a diagram illustrating a display example of a display unit of a management device.

FIG. 6 is a sequence diagram illustrating one example of a power-saving action management method.

FIG. 7 is a block diagram illustrating one example of a system configuration according to a modified example.

FIG. 8 is a sequence diagram illustrating one example of a power-saving action management method according to a modified example.

FIG. 9 is a diagram illustrating one example of operations of a management device according to a modified example.

FIG. 10 is a diagram illustrating a hardware configuration example of a management device.

### DESCRIPTION OF EMBODIMENTS

Hereinafter, an embodiment for performing the present disclosure will be described in detail with reference to the attached drawings. In description of the drawings, the same reference signs will be assigned to the same elements, and duplicate description will be omitted.

### (Power-Saving Action Management System)

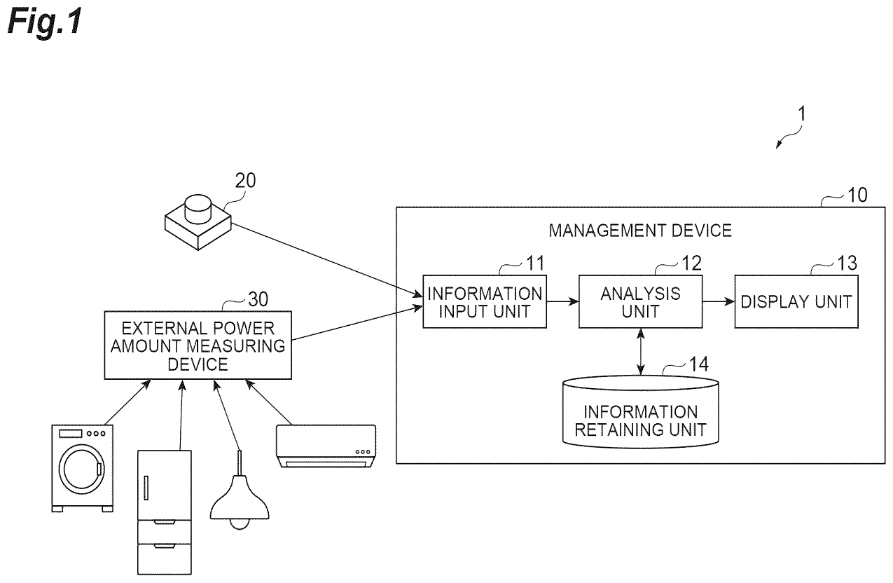

FIG. 1 illustrates a schematic configuration of a power-saving action management system 1 according to one embodiment of the present disclosure. As illustrated in FIG. 1, the power-saving action management system 1 is configured to include a management device 10 (a power-saving action management device), an intention notification member 20, and an external power amount measuring device 30.

The power-saving action management system 1 is a system that urges user's power-saving action by detecting a power-saving action based on a user's intention and notifying the user of an effect of the power-saving action. As a member used for detecting a user's intention, the intention notification member 20 is used, and as a device used for acquiring information relating to an actual power-saving effect according to a power saving action, the external power amount measuring device 30 is used. In addition, in this embodiment, a power-saving action is an action of reducing power consumption by switching the power of a power consuming device (for example, an electrical appliance) that can be used by a user from an on state to an off state. However, the action of reducing power consumption is not limited to switching of power from on to off, and, for example, like a change of a setting temperature or an operation mode in an air conditioner, an action of reducing power consumption in a state in which the on state of the power is maintained may be also included therein.

The management device 10 is a device that can be used by a user and has a function of notifying a user of a user's power-saving action and a result thereof. As one example, the management device 10 may be terminal device carried by a user, and more specifically, may be assumed to be a smartphone, a tablet terminal, or the like. In addition, the management device 10, for example, may be realized by a desktop-type computer or the like.

The intention notification member 20 is a member that is used for a user's expression of an intention of power saving and, as one example, may be a button-type device. For example, it is determined in advance that an operation of pressing a button will be performed in a case in which a user is to perform a power-saving action with his or her own intention. In other words, an operation for expressing an intention of a user himself or herself for power saving is determined in advance. Then, when the user performs the operation (an intention expressing operation) for expressing an intention for power saving, the intention notification member 20 notifies the management device 10 that this operation has been performed.

The external power amount measuring device 30 has a function of measuring a power consumption amount of a power consuming device that can be operated by a user. In a case in which the power-saving action management system 1 is used in a house, examples of a power consuming device that is a target for measuring a power consumption amount using the external power amount measuring device 30 include an electrical appliance and the like. Examples thereof include a house facility electric appliance, an electric cooking appliance, a home appliance such as a household appliance, a communication electrical appliance, an information electrical appliance, an AV electric appliance, and the like, but the power consuming device is not limited thereto. The power consuming device is a device of which power consumption can be adjusted in accordance with a user's operation. The external power amount measuring device 30, for example, records temporal changes of the power consumption amount of each electric appliance and transmits a result thereof to the management device 10. In accordance with this, in a case in which there are variations in power consumption of a power consuming device such as an electric appliance, the variations can be perceived also by the management device 10.

The management device 10 has a function of determining whether or not a user has performed a power-saving action with his or her intention on the basis of information from the intention notification member 20 and the external power amount measuring device 30 described above and displaying a result thereof. The management device 10 is configured to include an information input unit 11, an analysis unit 12, a display unit 13, and an information retaining unit 14.

The information input unit 11 acquires data in which power consumption [W] data of the external power amount measuring device 30 at predetermined times and information relating to an intention expression operation from the intention notification member 20 at that time are associated with each other. The acquired data may be retained in the information retaining unit 14 for a past predetermined period or may be retained in the information input unit 11.

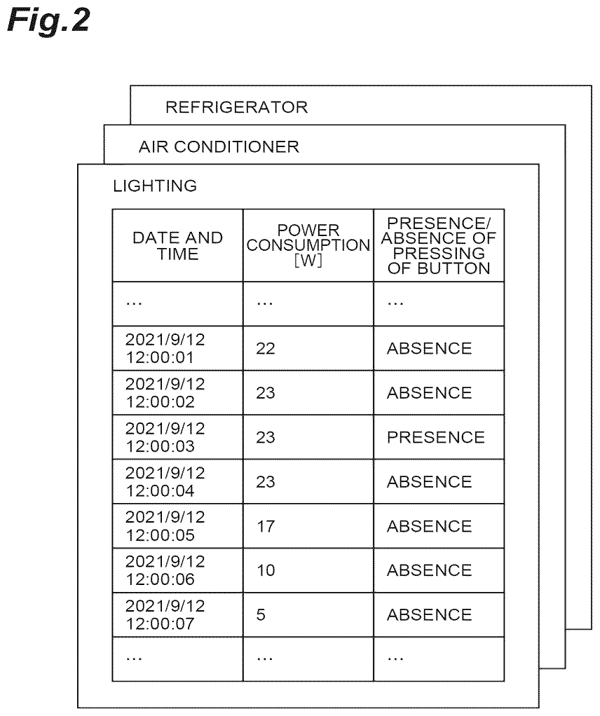

One example of data that is acquired by the information input unit 11 and is retained by the information retaining unit 14 is illustrated in FIG. 2. In the example illustrated in FIG. 2, relating to “lighting”, for each date and time, a power consumption [W] and information representing presence/absence of pressing of a button as an intention expression operation are associated with each other. In this example, although this information is acquired for every second, the acquisition interval of the power consumption data may be larger than this and, for example, may be set in the range of about one second to several minutes. The data relating to the power consumption is collected for each power consuming device such as an electric appliance.

In addition, in a case in which it is noticed from the intention notification member 20 that an intention expression operation (here, a button pressing operation) has been performed, information (here, “present”) representing that this operation has been performed is input in a row corresponding to a date and time at which the operation has been performed. By collecting such data, information representing a relation between an intention expression operation and a variation of the power consumption of each power consuming device can be acquired by the management device 10.

The analysis unit 12 determines whether or not a power-saving action has been actually performed before/after a user's intention expression operation on the basis of the information acquired by the information input unit 11. As an example of a technique for the determination, there is a method based on whether or not a power consumption amount of a specific electric appliance after an intention expression operation (after button pressing) has clearly decreased from a power consumption amount before the intention expression operation (before button pressing).

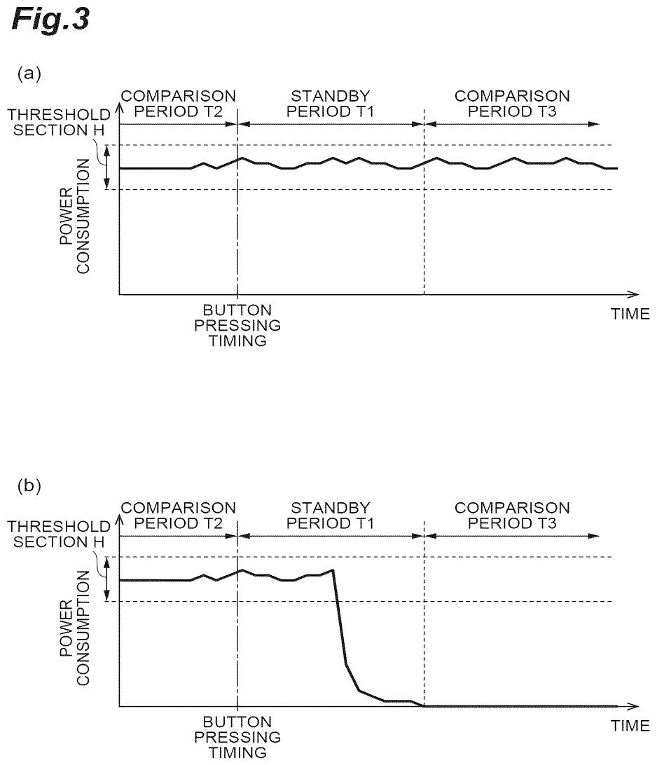

FIG. 3(a) illustrates an example of variations of power consumption of an air conditioner of a case in which a power-saving action is not performed. On the basis of a notification from the intention notification member 20, it is assumed that a user has performed an intention expression display operation (button pressing) at a specific timing. At this time, a predetermined time after the user has performed an intention expression operation is set to a standby period T1. At this time, a predetermined period before the intention expression operation is set as a comparison period T2, and a predetermined time after the standby period T1 is set as a comparison period T3. In addition, for each power consuming device, a threshold section H, which is a range of power variation that can be tolerated during normal operation, is set based on variation in power consumption during normal operation.

The analysis unit 12 refers to variations of the power consumption of each power consuming device of a standby period T1 set by being triggered upon an intention expression operation and determines whether or not the variations fall beyond the threshold section H. At this time, as illustrated in FIG. 3(a), the analysis unit 12 determines that a power consuming device of which power variations do not fall beyond the threshold section H is not a power consuming device having a possibility of being a target for a user's power-saving action. On the other hand, as illustrated in FIG. 3(b), in a case in which the power consumption of a power consuming device has changed to a degree of falling beyond the threshold section H in the standby period T1, power consumptions of comparison periods T2 and T3 are compared with each other, and it is checked whether the power consumption has changed. As illustrated in FIG. 3(b), in a case in which the power consumption has greatly changed between the comparison periods T2 and T3, and a power consumption relation of Power consumption of T2>Power consumption of T3 is satisfied, the power consuming device is determined to be a power consuming device for which a user's power-saving action is estimated to have been performed. According to the procedure described above, a device of which a power consumption has actually decreased after an intention expression operation can be identified, and thus a power consuming device for which a power-saving action is estimated to have been actually performed can be identified.

In addition, power consuming devices that become targets for the analysis described above may be not all the power consuming devices of which power consumption data is collected by the external power amount measuring device 30 and, for example, only devices that have already been in operation in a predetermined period (for example, devices consuming power within the threshold section H) until an intention expression operation (button pressing) is performed may be used. By employing such a configuration, erroneous recognition of a power variation originating from an operation different from a power-saving action as a power-saving action can be reduced. More specifically, in a case in which a user switches power of a power consuming device to an on state immediately before an intention expression operation and performs an operation of switching to the off state immediately after the intention expression operation, erroneous recognition of this operation as a power-saving action can be prevented.

In a case in which a power consuming device for which a power-saving action is estimated to have been actually performed is identified, the analysis unit 12 performs an analysis for identifying a degree of power saving that could be performed in accordance with a continuous power-saving action. More specifically, a time for a measured amount of power consumption to return from a changed state (a state of falling beyond the threshold section H) to an original state (a state of being included in the threshold section H) and a power consumption amount during that period are measured. Then, at a time point at which the measured amount of power consumption returns to the threshold section H, a power-saving amount according to the power-saving action is calculated.

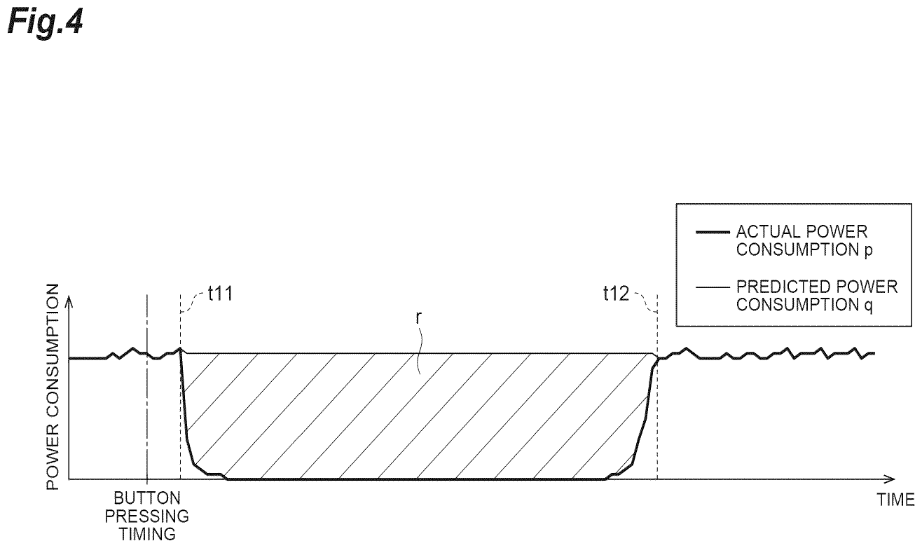

FIG. 4 illustrates one example when a power saving amount according to a power-saving action is calculated. In the example illustrated in FIG. 4, after an intention expression action is performed, an actual power consumption p decreases for a predetermined period (between t11 and t12). In this case, a difference sum r between a power consumption amount at a time at which a power-saving action is being performed (actual power consumption p) and a predicted power consumption amount at the same time at which the power-saving action is assumed not to be being performing (predicted power consumption q) illustrated in FIG. 4 becomes a reduced power consumption amount. In this way, the reduced power consumption amount can be identified on the basis of the actual power consumption p and the predicted power consumption q. In addition, by acquiring the reduced power consumption amount, a reduced electricity rate can be calculated.

The reduced electric amount (the power consumption amount) represented as the difference sum r illustrated in FIG. 4, for example, can be calculated on the basis of the following Numerical Expression (1). In addition, a reduced electricity rate corresponding to the reduced electric power amount can be calculated on the basis of the following Numerical Expression (2).

$$\begin{matrix}[ Math . 1 ] & \\ Reduced electric power amount [ kWh ] = ( {\sum }_{t = α}^{β} ( q - p ) ) * \frac{1}{36000000} & ( 1 )\end{matrix}$$

$$\begin{matrix}[ Math . 2 ] & \\ Reduced electricity rate [ Yen ] = ( {\sum }_{t = α}^{β} ( q - p ) ) * \frac{k}{36000000} & ( 2 )\end{matrix}$$

In Numeral Expressions (1) and (2), q is average power consumption [W] of a predetermined period before a button pressing timing, and p is actual power consumption [W] for every second. In addition, α is a start time [s] of change of the power consumption, and β is an end time [s] of change of the power consumption. Furthermore, k is a unit price (Yen/kWh) of the electricity rate.

A result of the above-described analysis performed by the analysis unit 12 may be stored in the information retaining unit 14. Particularly, information representing a result estimating that a power-saving action has been performed (information representing a relation between an intention expression operation and a variation of the power consumption before/after that) is retained in the information retaining unit 14. In addition, when the information representing a result estimating that a power-saving action has been performed is accumulated, by using this information, the analysis unit 12 may change a technique for determining whether or not a power-saving action has been performed. This point will be described below.

Referring back to FIG. 1, the display unit 13 performs display of various kinds of information on the basis of results of the analysis described above performed by the analysis unit 12. The display unit 13, for example, can be realized using a monitor or the like included in the management device 10. However, in a case in which a display screen such as a monitor is not included in the management device 10, the display unit 13, for example, may have a function of transmitting display details to an external device as a functional unit performing control for displaying various kinds of information in an external device having a display screen.

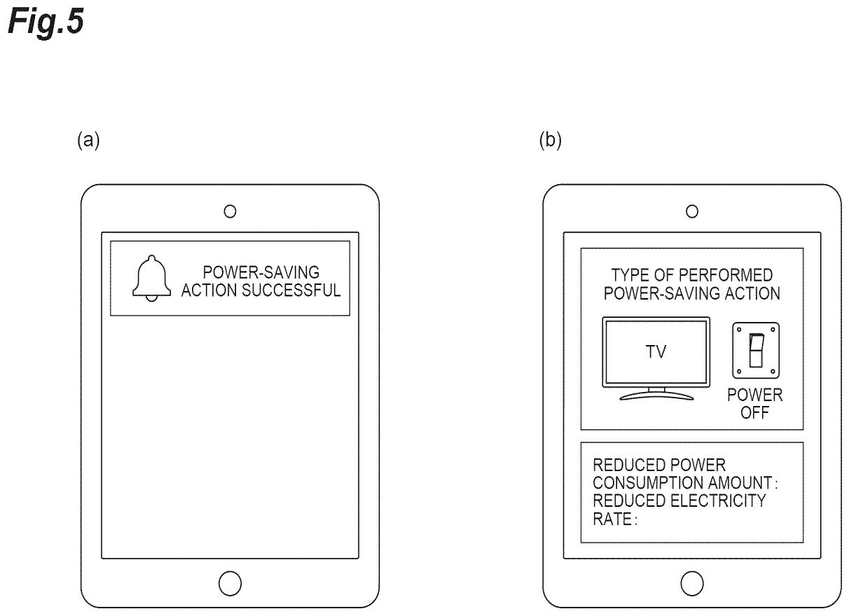

A screen display example using the display unit 13 of the management device 10 is illustrated in FIG. 5. The example illustrated in FIG. 5(a) is a display example in which, in a case in which it is estimated by the analysis unit 12 that a power-saving action based on a user's intention has been performed, a user is notified that a power-saving action is successful. In addition, the example illustrated in FIG. 5(b) is an example in which, in a case in which it is estimated by the analysis unit 12 that a power-saving action based on a user's intention has been performed, a type of the power-saving action (here, a power off operation of a television set is illustrated) and a reduced power consumption amount and a reduced electricity rate are displayed as a result of this action. In this way, in a case in which a user has performed a power-saving action, the display unit 13 may perform various kinds of display for the purpose of notifying a user that this action has been perceived in a device, notifying a user of a power-saving effect according to this action, and the like.

The information retaining unit 14, as described above, has a function of retaining information acquired from the intention notification member 20, information acquired from the external power amount measuring device 30, information relating to a result analyzed by the analysis unit 12, and the like. In addition, the information retaining unit 14 may retain information required for an analysis performed by the analysis unit 12.

### (Power-Saving Action Management Method)

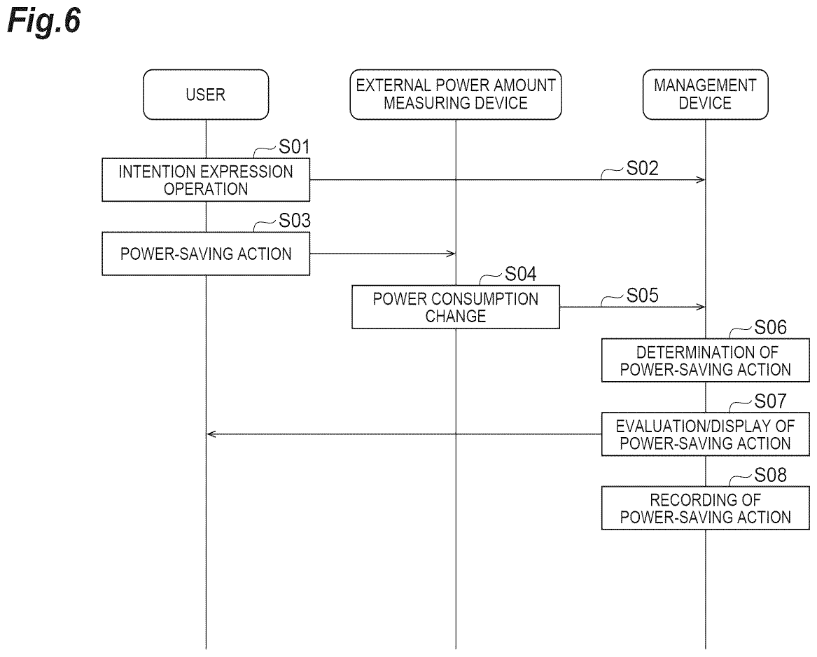

A power-saving action management method using the power-saving action management system 1 will be described with reference to FIG. 6. As a premise, although a power consumption amount is notified from the external power amount measuring device 30 to the management device 10 constantly with a predetermined interval and is acquired by the information input unit 11, this point is omitted in FIG. 6.

First, in a case in which a user has an intention for performing a power-saving action, the user performs an operation relating to an intention expression (Step S01). As one example, the user performs a button pressing operation of the intention notification member 20 and the like. When the user performs an intention expression operation using the intention notification member 20, it is notified to the management device 10 through the intention notification member 20 that the user has performed an intention expression operation, and the information input unit 11 acquires this information.

On the other hand, it is assumed that the user has actually performed a power-saving action for suppressing power consumption of the power consuming device (Step S03). At this time, the external power amount measuring device 30 detects a change of the power consumption according to a user's action (Step S04), and this information is transmitted from the external power amount measuring device 30 to the management device 10 (Step S05). In the management device 10, the analysis unit 12 determines whether or not a user has performed a power-saving action on the basis of a relation between an intention expression operation and a change of the power consumption (Step S06). As a result of the determination, in a case in which it is determined that the user has not performed a power-saving action (in other words, it cannot be identified that the power consumption has changed after the intention expression operation), subsequent processes are not particularly performed. On the other hand, as a result of the determination, in a case in which it is determined that the user has performed a power-saving action, a reduced power consumption amount and a reduced electricity rate are calculated as an evaluation of a power-saving effect according to a power-saving action, and results thereof are displayed using the display unit 13 (Step S07). By performing display using the display unit 13, an evaluation result of the effect according to the power-saving action calculated by the management device 10 is notified to the user. On the other hand, in the management device 10, data and the like used for a series of processes are retained in the information retaining unit 14. In addition, information representing a relation between a change of the power consumption and an intention expression operation in a case in which it is determined that a power-saving action has been performed may be retained separately from other information.

According to the procedure described above, a psychological aspect of “whether a user intends to perform a power-saving action” and a behavioral aspect of “whether a user has actually performed a power-saving action” can be determined. The psychological aspect of “whether a user intends to perform a power-saving action”, for example, can be perceived using an intention expression operation. On the other hand, the behavioral aspect of “whether a user has actually performed a power-saving action” can be estimated from the change in the power consumption of the power consuming device after an intention expression operation. In this way, the power-saving action management system 1 appropriately perceives a user's operation from both of the user's psychological and behavioral aspects relating to a power-saving action, appropriately evaluates a power-saving action performed by a user with his or her intention, and further notifies the user thereof. For this reason, recognition of power saving of a user handling the management device 10 can be raised, and a power-saving action can be promoted.

### MODIFIED EXAMPLE

The configuration of the power-saving action management system 1 described in the embodiment described above is one example, and various changes can be made therein. Hereinafter, representative modified examples will be described.

### First Modified Example of Analysis Relating to Power-Saving Action

In the procedure described above, when a state in which data for which it is determined that a power-saving action has been successful (a user has performed a power-saving action) (information representing a relation between a change of power consumption and an intention expression operation of a case in which it is determined that a power-saving action has been performed) is accumulated to some degrees is formed, it may be configured to determine whether the user has performed the power-saving action on the basis of this information. Hereinafter, two modified examples will be described.

In the first modified example, the configuration of the power-saving action management system 1 and the management device 10 are the same as the configuration illustrated in FIG. 1. However, a criterion for determining whether or not a power-saving action has been performed in the analysis unit 12 may be changed from that of the example described above.

More specifically, the analysis unit 12 determines whether or not a power-saving action has been performed on the basis of data (information identifying a timing at which an intention expression operation has been performed and information relating to a variation of power consumption) acquired by the information input unit 11 and information (past power-saving operation information) representing a relation between a change of power consumption and an intention expression operation of a case in which it is determined that a power-saving action has been performed, which is retained by the information retaining unit 14.

In this case, for example, in a case in which it is checked that the power consumption has varied in the standby period T1, the analysis unit 12 determines whether or not a reduced state of the power consumption amount of the power consuming device after the intention expression operation is performed is similar to the information retained by the information retaining unit 14, that is, information representing the relation between a change of the power consumption and the intention expression operation of a case in which it is determined that a power-saving action has been performed. As one example, the analysis unit 12 may calculate a degree of similarity using a known technique for calculating a degree of similarity such as dynamic time warping (DWT), a cross-correlations function (CCF), or the like and determine that a power-saving action has been performed in a case in which the degree of similarity is a predetermined threshold or more.

Also in a case in which the analysis unit 12 determines whether or not a power-saving action has been performed using the technique described above, a power-saving action management method using the power-saving action management system 1 is the same as that of the example described above. In other words, a series of processes can be performed in the procedure illustrated in FIG. 6.

In a case in which the technique according to this first modified example is employed, in a case in which a variation of the power consumption similar to a power-saving action estimated to be performed by a user with his or her intention in the past occurs, the management device 10 determines that the user has performed a power-saving action. For this reason, for example, in a case in which power consumption of a power consuming device has varied in accordance with a user's unintended operation or the like, the possibility of erroneously determining that the user has performed a power-saving action can be reduced, and it can be determined with higher accuracy whether not a user has performed a power-saving action with his or her intention.

### Second Modified Example of Analysis Relating to Power-Saving Action

In accordance with the procedure described above, when a state in which data for which it is determined that a power-saving action has been successful (a user has performed a power-saving action) (information representing a relation between a change of power consumption and an intention expression operation of a case in which it is determined that a power-saving action has been performed) is accumulated more is formed, for example, it may be configured to determine whether the user has performed the power-saving action without being triggered upon a user's intention expression operation. In a second modified example, a case in which it is estimated whether or not a user has performed a power-saving action without monitoring a user's intention expression operation will be described.

In the second modified example, since a user's intention expression operation is not used, when the configuration as the power-saving action management system 1 is compared with the configuration illustrated in FIG. 1, there is no intention notification member 20. In other words, the power-saving action management system 1 is configured to include the external power amount measuring device 30 and the management device 10. In addition, a criterion for determining whether or not a power-saving action has been performed in the analysis unit 12 may be different from that of the example described above.

More specifically, the analysis unit 12 determines whether or not a power-saving action has been performed on the basis of data (here, information relating to a variation of the power consumption) acquired by the information input unit 11 and information, which is retained in the information retaining unit 14, representing a relation between a change of power consumption of a case in which a power-saving action has been performed and an intention expression operation (past power-saving operation information).

In this case, for example, in a case in which it is checked that the power consumption varies in the standby period T1, the analysis unit 12, for example, by using a machine learning model that has learned information representing a relation between a change of the power consumption and an intention expression operation in a case in which it is determined that a power-saving action has been performed as learning data, which is retained by the information retaining unit 14, performs a time series analysis and the like using data (information relating to a change of the power consumption) input by the information input unit 11 as test data. By using such an analysis, it can be estimated whether a user's intention expression operation should have been performed, that is, whether the user has intended to take a power-saving action. An example of a machine learning model that can be used for this estimation includes a machine learning model that is effective for time series data such as a long short term memory (LSTM) network or a convolution LSTM network as a prediction technique. As a result of the analysis described above, in a case in which it is estimated that the user intends to take a power-saving action, it may be determined that the user has performed a power-saving action with his or her intention for the variation of the power consumption.

Also in a case in which the analysis unit 12 determines whether or not a power-saving action has been performed using the technique described above, a power-saving action management method using the power-saving action management system 1 is the same as that of the example described above. In other words, a series of processes may be performed in the procedure illustrated in FIG. 6. However, processes (Steps S01 to S02) relating to a user's intention expression action are not performed.

Also in a case in which the technique according to this second modified example is employed, in a case in which a variation of power consumption similar to that of a power-saving action estimated to have been performed in the past by the user with his or her intention has occurred, the management device 10 determines that the user has performed a power-saving action. In addition, it can be estimated whether or not a user has performed a power-saving action with his or her intention even when there is no actual intention expression operation of the user.

In addition, the technique for analyzing presence/absence of a power-saving action based on comparison for the comparison periods T2 and T3 described in the embodiment described above (a basic technique), the technique for analyzing presence/absence of a power-saving action using calculation of a degree of similarity based on past information which is described in the first modified example, and the technique for analyzing presence/absence of a power-saving action without referring to an intention expression operation described in the second modified example may be either independently used or used in parallel. For example, when switching from the basic technique to the technique based on the first modified example is performed, a possibility of performing biased determination due to past information and the like retained by the information retaining unit 14 may be considered. For this reason, for example, in the management device 10, the technique based on the first modified example may be operated in the form of assistance to the basic technique. In a case in which such an operation is continued, an operation in which determination using the basic technique is ended in a stage in which accuracy is determined to be sufficiently secured also in determination based on the first modified example may be performed.

In addition, although the technique based on the second modified example is a method not using a user's intention expression operation, this, for example, may be incorporated as an auxiliary technique in a condition in which the operation is performed using the basic technique described above or the technique based on the first modified example. As one example, there are cases in which a user forgets to perform an intention expression operation and cannot acquire a notification from the intention notification member 20 in the management device 10. Even in such a condition, in a case in which it can be estimated that a user has performed a power-saving action when the technique of the second modified example is applied to the information relating to a variation of the power consumption in the analysis unit 12, by determining that the user has performed a power-saving action, an operation of presenting information, which is similar to the information notified to the user when a power-saving action is determined to have been performed, to the user may be configured to be performed.

In addition, the technique of the second modified example includes a possibility of determining a variation of power consumption in which a user is not engaged as a result of a user's power-saving action. Thus, for example, in a case in which estimation is performed using the technique of the second modified example, before finally determining that a power-saving action has been performed, a process of checking whether or not the user has performed a power-saving action for the user may be added.

### First Modified Example for Urging User's Power-Saving Action

Next, a modified example for further promoting a user's power-saving action with his or her intention will be described.

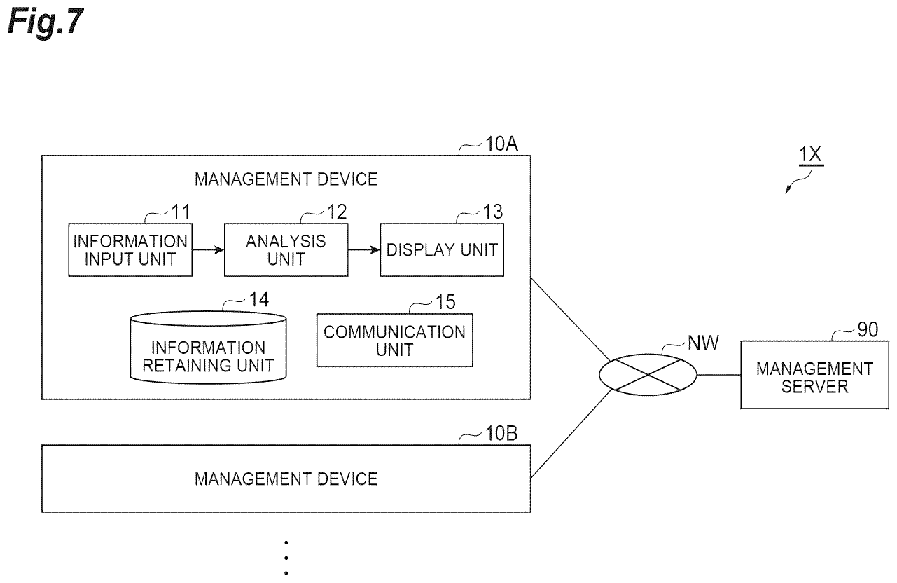

As a first modified example, as a configuration for simultaneously promoting power-saving actions relating to a plurality of users, as illustrated in FIG. 7, a management system 1X in which a management server 90 supervising a plurality of power-saving action management systems 1 is separately provided may be configured. Basically, the management device 10 is a system (device) that manages a power-saving action of one user. Thus, by using the management system 1X, a configuration in which power-saving actions are urged by assigning an incentive according to a user's power-saving action for a plurality of users who are management targets of a plurality of management devices 10 may be employed.

In a case in which the management system 1X including the management server 90 is configured, the management server 90 can communicate with a plurality of management devices 10 (10A, 10B, . . . ) through a radio communication network NW. In addition, the management device 10 has a communication unit 15 for enabling communication with the management server 90, which is different from the configuration example of the management device 10 described above.

The communication unit 15, for example, may have a function of notifying a result of a power-saving action to the management server 90 by communicating with the management server 90. In addition, by receiving information provided by the management server 90 and displaying the received information in the display unit 13, it may be possible to present information for promoting a user's power-saving action.

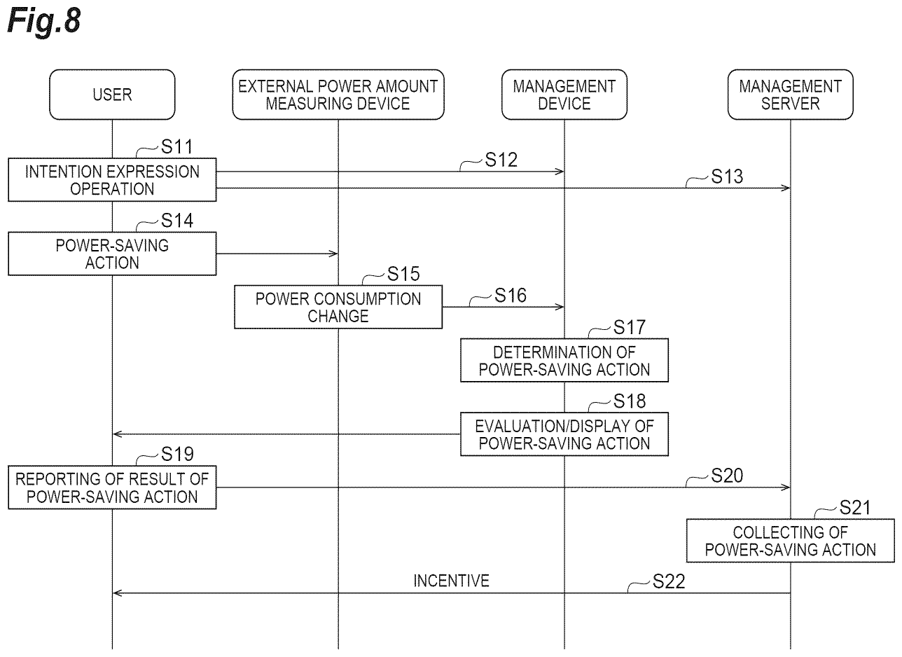

In the management system 1X including the management server 90, one example of a process of managing user's power-saving actions will be described with reference to FIG. 8. In FIG. 8, the procedure of the process of a case in which the management server 90 provides a social networking service (SNS) that can be used by users of the management devices 10 under the control thereof and provides points to a user who has performed a power-saving action as an incentive will be described.

First, in a case in which a user has an intention to perform a power-saving action, the user performs an operation relating to an intention expression (Step S11). As one example, the user performs a button pressing operation for the intention notification member 20. When a user performs an intention expression operation using the intention notification member 20, it is notified to the management device 10 through the intention notification member 20 that the user's intention expression operation has been performed, and this information is acquired by the information input unit 11 (Step S12). In addition, as an intention expression operation of a user, the user may write a post relating to the intention expression to the SNS provided by the management server 90 by operating the management device 10 (Step S13). In a case in which the management server 90 provides an SNS, the user's post may be shared with other users. Thus, the other users are assumed to be urged to perform a power-saving action.

After the operation described above, similar to the procedure illustrated in FIG. 6, a process of evaluating whether a user has actually performed a power-saving action is performed. More specifically, a user is assumed to have actually performed a power-saving action for suppressing power consumption of a power consuming device (Step S14). The external power amount measuring device 30 detects a change of the power consumption according to the user's action (Step S15), and this information is transmitted from the external power amount measuring device 30 to the management device 10 (Step S16). The analysis unit 12 of the management device 10 determines whether or not a user has performed a power-saving action on the basis of the relation between an intention expression operation and a change of the power consumption (Step S17). As a result of the determination, in a case in which it is determined that the user has performed the power-saving action, as an evaluation of a power-saving effect according to the power-saving action, a reduced power consumption amount and a reduced electricity rate are calculated, and a result thereof is displayed using the display unit 13 (Step S18). By displaying the result using the display unit 13, the result of the evaluation of the effect according to the power-saving action that is calculated by the management device 10 is notified to the user.

The user may write a post reporting a result of actual performance of the power-saving action to an SNS provided by the management server 90 (Step S19). For example, the user may post a result of a power-saving action (more specifically, a reduced power consumption/electricity rate or the like) to the SNS by operating the management device 10. This post of this user may be shared with other users. Thus, the other users are assumed to be urged to perform a power-saving action. In addition, in accordance with the posting of the user, the management server 90 can acquire a result of power saving of the user (Step S20).

The management server 90 may collect results of power-saving actions of users on the basis of postings of the users (Step S21). In addition, in accordance with collected results, for example, an incentive may be configured to be provided for a user who has significantly reduced power consumption (Step S22).

In addition, in a case in which another user other than a user who wrote posts relating to an intention expression and a report of a power-saving action performs a power-saving action after reading the posts described above, the management server 90 may be configured to give points as an incentive. In this case, an effect of promotion of a power-saving action for the other users (users of the reading side) is assumed to be raised.

As described above, in a case in which an SNS dedicatedly used by users using the management device 10 is provided by the management server 90, by using user's postings to this SNS, encouragement, competition, or the like among the users can be induced.

In addition, in the example illustrated in FIG. 8, although incentive giving using an SNS has been described, the management server 90 may be configured not to provide an SNS. For example, the management server 90 may be configured to have a function of collecting results of power-saving actions from a plurality of management devices 10 and give an incentive to each user in accordance with the collected results. In this way, results of power-saving actions of a plurality of users are collected using the management server 90, and a user's power-saving action may be configured to be promoted using this.

### Second Modified Example for Urging User's Power-Saving Action

By changing a partial configuration of the power-saving action management system 1 used for one user instead of disposing the management server 90 as described above, a configuration for urging a user to perform a power-saving action may be employed.

For example, in the embodiment described above, although a case in which a target for which a user performs an intention expression operation is the intention notification member 20 has been described, a target for which an intention expression operation is performed and the management device 10 may be integrally configured. For example, in a case in which the management device 10 is configured using a terminal device carried by a user, the above-described function of the management device 10 (the function of perceiving a user's power-saving action and controlling display of an evaluation result thereof) may be realized as one application. In that case, for example, a configuration in which a button corresponding to an intention expression operation is set inside the application, and a case in which the button is touched by the user is handled as an intention expression operation may be employed. In addition, a configuration in which a user's startup of an application is handled as an intention expression operation may be employed.

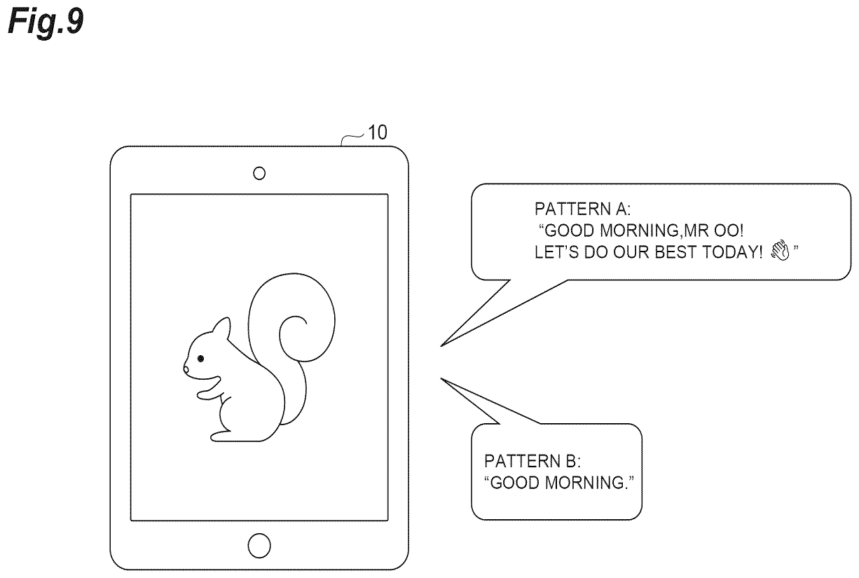

Furthermore, similar to the modified example described above, instead of causing users to contend each other, by configuring the single management device 10 such that the operation of the management device 10 is changed in accordance with the number of user's power-saving actions, a power-saving action may be configured to be promoted for the user. As one example, FIG. 9 illustrates an example in which, in a case in which a user starts up an application relating to power-saving action management, a message for the user is changed. In FIG. 9, as an example of two types of messages, Pattern A “Good morning, Mr. OO! Let's do our best today!” that is a greeting message accompanying the user and Pattern B “Good morning.” of only a greeting are illustrated. For example, a configuration in which, in a case in which a result of a user's power-saving action (a reduced power consumption amount or a reduced electricity rate) of the previous day in the management device 10 is larger than a predetermined value, Pattern A is presented to the user, and otherwise, Pattern B is presented to the user may be employed. By employing such a configuration, a user can be urged to actively perform a power-saving action by being able to refer to the greeting message of Pattern A. In addition, although a simple example is illustrated in FIG. 9, in order to further promote a user's power-saving action, a specification in which, in a case in which a predetermined condition is satisfied, the management device 10 performs a special operation or the like may be used.

### (Operations)

In the management device 10 (the power-saving action management device) included in the power-saving action management system 1 described above, the analysis unit 12 analyzes a relation between the change in the power consumption of the power consuming device and a user's intention expression operation. More specifically, the analysis unit 12 determines whether or not a user has actually performed a power-saving action from information representing that the user has performed an intention expression operation expressing an intention to spontaneously perform power saving and information relating to a temporal change in the power consumption of the power consuming device, and a result thereof is displayed in the display unit 13. By employing the configuration described above, it can be more appropriately determined whether the change in the power consumption of the power consuming device has originated from a user's intentional power-saving action. In other words, the management device 10 can detect a user's power-saving action more accurately. In addition, by displaying that a power-saving action has been performed using the display unit 13, appropriate detection of a power-saving action is notified also to the user, and thus a user's power-saving action can be promoted. The information input unit 11 may acquire information relating to temporal changes in power consumptions of a plurality of power consuming devices from the external power amount measuring device 30 that manages the information relating to temporal changes in the power consumptions of the plurality of power consuming devices. In addition, the analysis unit 12 may estimate a power consuming device for which a user has performed a power-saving action from the information relating to the temporal changes in the power consumptions of the plurality of power consuming devices. In a case in which there is a possibility of a user performing a power-saving action for a plurality of power consuming devices like in the case of the inside of a house, the management device 10 may acquire information relating to variations of power consumption from the plurality of power consuming devices as described above and estimate a device for which the user has performed the power-saving action. In such a case, by transmitting and receiving information through the external power amount measuring device 30, the management device 10 may be configured not to individually communicate with a plurality of power consuming devices, and thus transmission/reception of information can be more appropriately performed in more real-time. In addition, in the embodiment described above, although a case in which the information relating to variations of power consumption is acquired from a plurality of power consuming device has been assumed in description, the management device 10, for example, may be configured to manage a power-saving action only for one power consuming device as a target. In such a case, the information relating to variations of power consumption may be configured to be directly acquired from the power consuming device.

The analysis unit 12 may determine whether a user has performed a power-saving action for a power consuming device on the basis of presence/absence of the change in the power consumption of the power consuming device in a predetermined period before/after a user's intention expression operation. By employing a configuration in which whether or not a power-saving action has been performed is determined by monitoring a change of the power consumption of the predetermined period before/after an intention expression operation by being triggered upon the intention expression operation, a case in which a user has performed a power-saving action with his or her intention can be identified more accurately.

In a case in which it is determined that a user has performed the power-saving action described above, the display unit 13 may display information used for identifying a power consuming device for which the power saving action has been performed (for example, information representing a certain power consuming device for which the power-saving action has been performed) and information relating to power consumption that could be reduced as a result of the power-saving action (a power consumption amount or an electricity rate). By employing such a configuration, it can be presented to the user more specifically that a result of a user's power-saving action is checked by the management device 10. Since a user can more specifically perceive a result of a power-saving action, a power-saving action thereafter can be further more promoted.

The information retaining unit 14 that retains information used for identifying that a user has performed an intention expression operation and information relating to a temporal change in power consumption of a power consuming device in a case in which the user is estimated to have performed the power-saving action before/after this operation in association with each other as past power-saving operation information may be further included. In addition, the analysis unit 12 may determine whether a user has performed a power-saving action for a power consuming device before/after a user's intention expression operation on the basis of similarity to the past power-saving operation information retained in the information retaining unit 14. By employing such a configuration, it can be more accurately perceived whether or not a user has performed a power-saving action.

The management device 10 described in the embodiment described above is a management device that determines a psychological aspect of “whether a user intends to perform a power-saving action” and a behavioral aspect of “whether a user has actually performed a power-saving action” using measured data of the external power amount measuring device 30 and a button pressing instruction (an intention expression operation) before a power-saving action of the outside. The management device 10 includes the information input unit 11 that receives power consumption data of the external power amount measuring device 30 at predetermined times and information representing whether or not an external button has been pressed, the analysis unit 12 that determines whether or not a power-saving action has been performed before/after pressing of the external button from data input by the information input unit 11, the information retaining unit 14 as a database unit storing data of the information input unit of a case in which the power-saving action determined by the analysis unit 12 has been performed, and the display unit 13 that displays information determined by the analysis unit 12.

According to the configuration described above, a detailed power-saving action and an effect thereof that could not be measured without spending a high implementation cost up to now can be estimated at a low cost, and a previously unclear contribution of a user's power-saving action is presented as a clear index, and thus it can be an index of a user's power-saving action performed thereafter.

As separate aspects of the power-saving action management system 1 and the power-saving action management method described above, there are a management device or a management method illustrated below.

[Item 1] A management device performing determination of a psychological aspect of “whether a user intends to perform a power-saving action” and a behavioral aspect of “whether a user has actually performed a power-saving action”, the management device includes: an information input unit receiving power consumption data of an external power amount measuring device at predetermined times and whether or not an external button has been pressed; a selection unit (an analysis unit) determining whether or not a power-saving action has been performed before/after pressing of the external button from data input by the information input unit; a database unit (an information retaining unit) storing data of the information input unit of a case in which the power-saving action determined by the selection unit has been performed; and a display unit displaying information determined by the selection unit.
[Item 2] The management device described in Item 1 in which the information input unit described above stores data that associates power consumption data of an external power amount measuring device at predetermined times in real time and a pressed state of an external button at those corresponding times for a predetermined period in the past.
[Item 3] The management device described in Item 1 or 2 in which the selection unit determines whether or not a power-saving action has been performed before/after pressing of the external button from data input by the information input unit.
[Item 4] The management device described in any one of Items 1, 2, and 3 in which, the database unit stores data of a predetermined period before/after pressing of the button of a case in which the selection unit “determines that the data from the information input unit is plausible as a power-saving action” in the database unit.
[Item 5] The management device described in any one of Items 1, 2, and 3 in which the presentation unit, in a case in which it is determined whether the user has performed a power-saving action on the basis of a result of selection in the selection unit described above, is able to calculate and display a type of the power-saving action, and a power consumption amount and an electricity rate that have been reduced.

### (Others)

Each block diagram used for description of the embodiment illustrates blocks in units of functions. Such functional blocks (component units) are realized by an arbitrary combination of at least one of hardware and software. In addition, a method for realizing each functional block is not particularly limited. In other words, each functional block may be realized by using one device that is combined physically or logically or using a plurality of devices by directly or indirectly (for example, using a wire, wirelessly, or the like) connecting two or more devices separated physically or logically. A functional block may be realized by one device or a plurality of devices described above and software in combination. In addition, the term “device” described in this embodiment may be rephrased as a circuit, a device, a unit, or the like.

As functions, there are deciding, determining, judging, computing, calculating, processing, deriving, inspecting, searching, checking, receiving, transmitting, outputting, accessing, solving, selecting, choosing, establishing, comparing, assuming, expecting, regarding, broadcasting, notifying, communicating, forwarding, configuring, reconfiguring, allocating, mapping, assigning, and the like, and the functions are not limited thereto. For example, a functional block (constituent unit) enabling transmission to function is referred to as a transmitting unit or a transmitter. As described above, a method for realizing all the functions is not particularly limited.

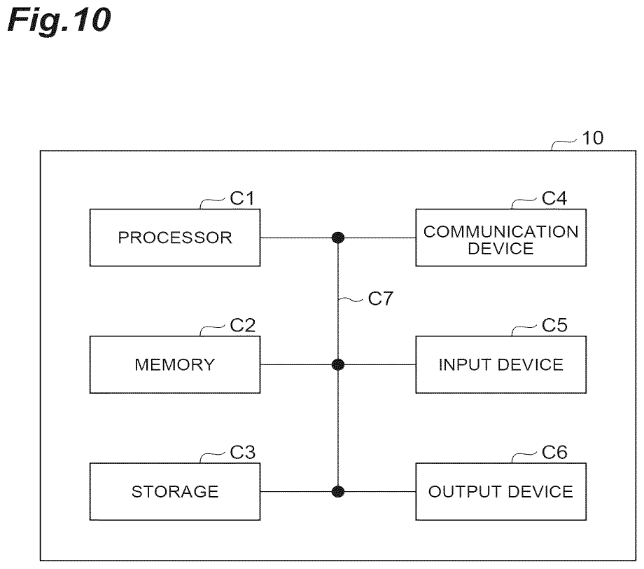

FIG. 10 is a diagram illustrating an example of a hardware configuration of the management device 10 included in the power-saving action management system according to this embodiment. The management device 10 functioning as the power-saving action management device may be physically configured as a computer device including a processor C1, a memory C2, a storage C3, a communication device C4, an input device C5, an output device C6, a bus C7, and the like.

In addition, in the following description, a term “device” may be rephrased as a circuit, a device, a unit, or the like. The hardware configuration of the management device 10 functioning as the power-saving action management device may be configured to include one or a plurality of devices illustrated in FIG. 10. In addition, the hardware configuration may be configured not to include some devices.

Each function of the management device 10 may be realized when the processor C1 performs an arithmetic operation by causing predetermined software to be read onto hardware such as the processor C1, the memory C2, and the like, controls communication using the communication device C4, and controls at least one of data reading and data writing for the memory C2 and the storage C3.

The processor C1, for example, controls the entire computer by operating an operating system. The processor C1 may be configured by a central processing unit (CPU) including an interface with peripheral devices, a control device, an arithmetic operation device, a register, and the like. In addition, the processor C1 may be configured to include a graphics processing unit (GPU). For example, each functional unit and the like of the management device 10 may be realized by the processor C1.

In addition, the processor C1 reads a program (program code), a software module, data, and the like from at least one of the storage C3 and the communication device C4 into the memory C2 and executes various processes in accordance with these. As the program, a program causing a computer to execute at least some of the operations described in the embodiment described above is used. For example, each functional unit of the management device 10 may be realized by a control program that is stored in the memory C2 and operated by the processor C1. Although the various processes described above have been described as being executed by one processor C1, the processes may be executed simultaneously or sequentially by two or more processors C1. The processor C1 may be realized using one or more chips. In addition, the program may be transmitted from a network through a telecommunication line.

The memory C2 is a computer-readable recording medium and, for example, may be configured by at least one of a read only memory (ROM), an erasable programmable ROM (EPROM), an electrically erasable programmable ROM (EEPROM), a random access memory (RAM), and the like. The memory C2 may be referred to as a register, a cache, a main memory (a main storage device), or the like. The memory C2 can store a program (a program code), a software module, and the like executable for performing the power-saving action management method according to one embodiment of the present invention.

The storage C3 is a computer-readable recording medium and, for example, may be configured by at least one of an optical disc such as a compact disc ROM (CD-ROM), a hard disk drive, a flexible disk, a magneto-optical disk (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage C3 may be referred to as an auxiliary storage device. The storage medium described above, for example, may be a database including the memory C2 and/or the storage C3, a server, or any other appropriate medium.

The communication device C4 is hardware (a transmission/reception device) for performing inter-computer communication through at least one of a wired network and a wireless network and, for example, may be called also a network device, a network controller, a network card, a communication module, or the like.

The input device C5 is an input device (for example, a keyboard, a mouse, a microphone, a switch, buttons, a sensor, or the like) that accepts an input from the outside. The output device C6 is an output device (for example, a display, a speaker, an LED lamp, or the like) that performs output to the outside. In addition, the input device C5 and the output device C6 may have an integrated configuration (for example, a touch panel).

In addition, devices such as the processor C1, the memory C2, and the like are connected using a bus C7 for communication of information. The bus C7 may be configured as a single bus or buses different between devices.

The processing sequence, the sequence, the flowchart, and the like of each aspect/embodiment described in the present disclosure may be changed in order as long as there is no contradiction. For example, in a method described in the present disclosure, elements of various steps are presented in an exemplary order, and the method is not limited to the presented specific order.

The input/output information and the like may be stored in a specific place (for example, a memory) or managed using a management table. The input/output information and the like may be overwritten, updated, or added to. The output information and the like may be deleted. The input information and the like may be transmitted to another device.

A judgment may be performed using a value (“0” or “1”) represented by one bit, may be performed using a Boolean value (true or false), or may be performed using a comparison between numerical values (for example, a comparison with a predetermined value).

The aspects/embodiments described in the present disclosure may be individually used, used in combination, or be switched therebetween in accordance with execution. In addition, a notification of predetermined information (for example, a notification of being X) is not limited to being performed explicitly and may be performed implicitly (for example, a notification of the predetermined information is not performed).

It is apparent that software, regardless of whether it is called software, firmware, middleware, a microcode, a hardware description language, or any other name, may be widely interpreted to mean a command, a command set, a code, a code segment, a program code, a program, a subprogram, a software module, an application, a software application, a software package, a routine, a subroutine, an object, an executable file, an execution thread, an order, a function, and the like.

In addition, software, a command, information, and the like may be transmitted and received via a transmission medium. For example, in a case in which software is transmitted from a website, a server, or any other remote source using at least one of a wiring technology such as a coaxial cable, an optical fiber cable, a twisted pair, a digital subscriber line (DSL) or the like and a radio technology such as infrared rays, radio waves, microwaves, or the like, at least one of such a wiring technology and a radio technology is included in the definition of the transmission medium.

Information, a signal, and the like described in the present disclosure may be represented using any one among other various technologies. For example, data, an instruction, a command, information, a signal, a bit, a symbol, a chip, and the like described over the entire description presented above may be represented using a voltage, a current, radiowaves, a magnetic field or magnetic particles, an optical field or photons, or an arbitrary combination thereof.

Terms such as “system” and “network” used in the present disclosure are interchangeably used.

Terms such as “determining” used in the present disclosure may include various operations of various types. The “determining”, for example, may include a case in which judging, calculating, computing, processing, deriving, investigating, looking up, search, and inquiry (for example, looking up a table, a database, or any other data structure), or ascertaining is regarded as “determining”. In addition, “determining” may include a case in which receiving (for example, receiving information), transmitting (for example, transmitting information), input, output, or accessing (for example, accessing data in a memory) is regarded as “determining”. Furthermore, “determining” may include a case in which resolving, selecting, choosing, establishing, comparing, or the like is regarded as “determining”. In other words, “determining” includes a case in which a certain operation is regarded as “determining”. In addition, “determining” may be rephrased with “assuming”, “expecting”, “considering”, and the like.

Terms such as “connected” or “coupled” or all the modifications thereof mean all the kinds of direct or indirect connection or coupling between two or more elements and may include presence of one or more intermediate elements between two elements that are mutually “connected” or “coupled”. Coupling or connection between elements may be physical coupling or connection, logical coupling or connection, or a combination thereof. For example, “connection” may be rephrased with “access”. When used in the present disclosure, two elements may be considered as being mutually “connected” or “coupled” by using one or more wires and at least one of a cable and a print electric connection and, as several non-limiting and non-comprehensive examples, by using electromagnetic energy having wavelengths in a radio frequency region, a microwave region, and a light (both visible light and non-visible light) region.

Description of “on the basis of” used in the present disclosure does not mean “only on the basis of” unless otherwise mentioned. In other words, description of “on the basis of” means both “only on the basis of” and “on the basis of at least.”

In a case in which “include,” “including,” and modifications thereof are used in the present disclosure, such terms are intended to be inclusive like a term “comprising.” In addition, a term “or” used in the present disclosure is intended to be not an exclusive logical sum.

In the present disclosure, for example, in a case in which an article such as “a,” “an,” or “the” in English is added through a translation, the present disclosure may include a plural form of a noun following such an article.

In the present disclosure, a term “A and B are different” may means that “A and B are different from each other”. In addition, the term may mean that “A and B are different from C”. Terms “separated”, “combined”, and the like may be interpreted similar to “different”.

### REFERENCE SIGNS LIST

1 Power-saving action management system
10 Management device
11 Information input unit
12 Analysis unit
13 Display unit
14 Information retaining unit
15 Communication unit
20 Intention notification member
30 External power amount measuring device

1. A power-saving action management device comprising circuitry configured to:
acquire information relating to a temporal change in power consumption of a power consuming device for which adjustment of power consumption can be performed by a user and information representing that the user has performed an intention expression operation that is an operation expressing an intention to spontaneously perform power saving;
analyze a relation between the change in the power consumption of the power consuming device and the user's intention expression operation; and
display a result of the analysis,
wherein the circuitry identifies whether the user has performed a power-saving action for the power consuming device before/after the user's intention expression operation, and
in a case in which it is identified that the user has performed the power-saving action, displays the result.

2. The power-saving action management device according to claim 1,
wherein the circuitry acquires information relating to temporal changes in power consumptions of a plurality of power consuming devices from an external power amount measuring device managing the information relating to the temporal changes in the power consumptions of the plurality of power consuming devices, and
estimates a power consuming device for which the user has performed the power-saving action from the information relating to the temporal changes in the power consumptions of the plurality of power consuming devices.

3. The power-saving action management device according to claim 1, wherein the circuitry determines whether the user has performed the power-saving action for a power consuming device on the basis of presence/absence of the change in the power consumption of the power consuming device in a predetermined period before/after the user's intention expression operation.

4. The power-saving action management device according to claim 1, wherein, in a case in which it is determined that the user has performed the power-saving action, the circuitry displays information for identifying a power consuming device for which the power-saving action has been performed and information relating to power consumption that could be reduced as a result of the power-saving action.

5. The power-saving action management device according to claim 1, wherein the circuitry retains information for identifying that the user has performed an intention expression operation and information relating to the temporal change in the power consumption of the power consuming device of a case in which the user is estimated to have performed the power-saving action before/after the operation in association with each other as past power-saving operation information, and
determines whether the user has performed the power-saving action for the power consuming device before/after the user's intention expression operation on the basis of similarity to the past power-saving operation information.

6. The power-saving action management device according to claim 2, wherein the circuitry determines whether the user has performed the power-saving action for a power consuming device on the basis of presence/absence of the change in the power consumption of the power consuming device in a predetermined period before/after the user's intention expression operation.
